(19) United States
(12) Patent Application Publication
(10) Pub. No.: US 2011/0165392 A1
(43) Pub. Date: Jul. 7, 2011

(54) TRANSPARENT CONDUCTIVE FILM AND DISPLAY FILTER INCLUDING THE SAME

(75) Inventors: Sung Nim JO, ChungCheongNam-Do (KR); Eui Soo KIM, ChungCheongNam-Do (KR); You Min SHIN, ChungCheongNam-Do (KR)

(73) Assignee: SAMSUNG CORNING PRECISION MATERIALS CO., LTD.

(21) Appl. No.: 12/983,087

(22) Filed: Dec. 31, 2010

(30) Foreign Application Priority Data
Jan. 4, 2010 (KR) 10-2010-0000121

(51) Int. Cl. B32B 7/02

(52) U.S. Cl. 428/213

(57) ABSTRACT

A transparent conductive film includes first refractive transparent thin films and metal thin films. The first refractive transparent thin films and metal thin films are repeatedly layered over a transparent substrate. Each of second refractive thin films having a smaller refractive index than the first refractive thin films is interposed between a corresponding first refractive transparent thin film and a corresponding metal thin film. Each second refractive thin film has a thickness ranging from 10% to 65% of that of each of the first refractive thin films.

### CROSS REFERENCE TO RELATED APPLICATION

The present application claims priority from Korean Patent Application Number 10-2010-0000121 filed on Jan. 4, 2010, the entire contents of which application are incorporated herein for all purposes by this reference.

### BACKGROUND OF THE INVENTION

1. Field of the Invention

The present invention relates to a transparent conductive film and a display filter including the same, and more particularly, to a transparent conductive film which exhibits high light transmissivity and high Near Infrared (NIR) shielding performance, and is not deformed in a hot and humid environment due to its low internal stress, and a display filter including the same.

2. Description of Related Art

A transparent conductive film, which generally has a multiple thin film structure in which oxide transparent thin films and metal thin films are repeatedly layered over each other, is widely used as an electromagnetic shielding member of a Plasma Display Panel (PDP), a windshield of a vehicle, an electromagnetic shielding windowpane, a transparent electrode of a display device, etc.

As the range of application of the transparent conductive film is widened, moisture resistance and high durability characteristics, which prevent defects and deterioration from occurring even in a high-temperature environment or the like, are required in addition to high transmissivity in the visible light range and high electrical conductivity.

However, there is a problem in that, if the number of layers of the transparent conductive film is increased in order to reduce the resistance thereof, the internal stress of the thin films is increased, thereby making the conductive film susceptible to fracture. This causes the resistance thereof to increase. Additionally, in a high-humidity environment, this causes white defects to occur due to Ag condensation.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a transparent conductive film, which exhibits high light transmissivity and high Near Infrared (NIR) shielding performance, and is not deformed in a hot and humid environment due to its low internal stress, and a display filter including the same.

In an aspect of the present invention, the transparent conductive film includes first refractive transparent thin films and metal thin films. The first refractive transparent thin films and metal thin films are repeatedly layered over a transparent substrate. Each of second refractive thin films having a smaller refractive index than the first refractive thin films is interposed between a corresponding first refractive transparent thin film and a corresponding metal thin film. Each second refractive thin film has a thickness ranging from 10% to 65% of that of each of the first refractive thin films.

It is preferred that the first refractive transparent thin films be made of a metal oxide having a refractive index of 2.2 or more.

According to embodiments of the invention, in the transparent conductive film and the display filter including the same, the thickness of each second refractive transparent thin film having a relatively lower refractive index ranges from 10% to 65% of that of each first refractive transparent thin film. This improves the crystallinity of the metal thin films of the conductive film, thereby providing advantageous effects, such as improved electrical conductivity and a visible light transmissivity satisfying a normally required range (80% or more). In addition, Near Infrared (NIR) shielding performance is excellent.

In addition, since the metal thin films are crystalline, it is possible to prevent moisture from causing Ag condensation. This can reduce the occurrence of defects in a hot and humid environment, thereby maintaining an excellent appearance and improving the durability, particularly, moisture resistance, of the metal thin films.

Moreover, since the metal thin films are crystalline, they have excellent electrical conductivity even if the number of layers of the conductive films is not increased. This also reduces the condensation in the Infrared (IR) reflecting metal thin films, thereby realizing strong durability even if exposed to a hot and humid environment.

The methods and apparatuses of the present invention have other features and advantages which will be apparent from, or are set forth in more detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a cross-sectional view for explaining a transparent conductive film according to an exemplary embodiment of the invention; and

FIG. 2 is a cross-sectional view showing a transparent conductive film according to an example of the invention.

### DETAILED DESCRIPTION OF THE INVENTION

Reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments that may be included within the spirit and scope of the invention as defined by the appended claims.

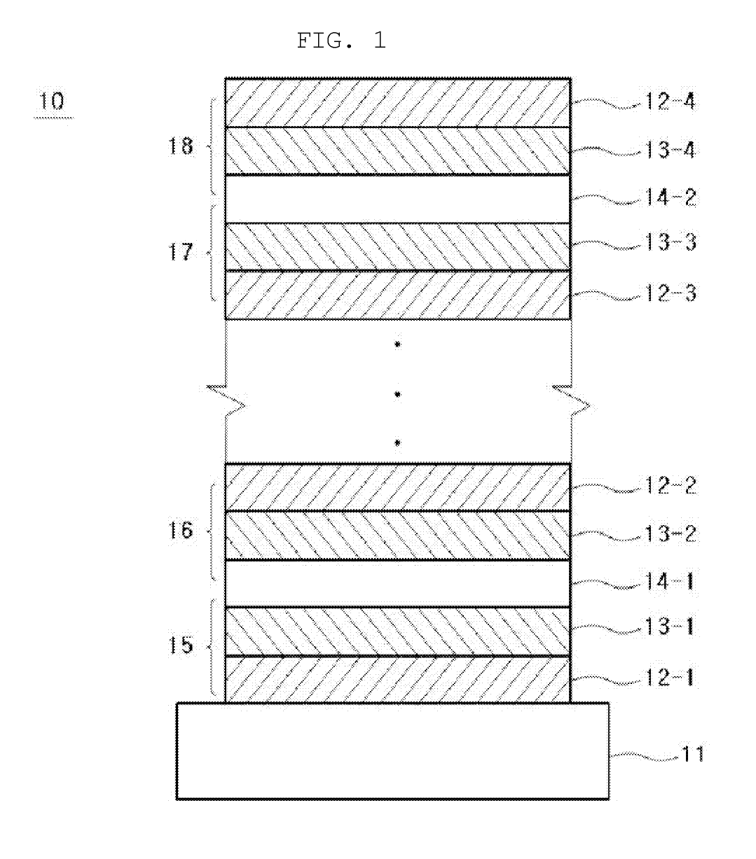

FIG. 1 is a cross-sectional view for explaining a transparent conductive film according to an exemplary embodiment of the invention.

As shown in FIG. 1, the transparent conductive film 10 of the invention includes multilayer thin film structures 15, 16, 17, and 18, in which first refracting transparent thin films 12-1, 12-2, 12-3, and 12-4, second refracting transparent thin films 13-1, 13-2, 13-3, and 13-4, and metal thin films 14-1 and 14-2 are layered over a transparent substrate 11. It is preferred that each of the second transparent thin films 13-1, 13-2, 13-3, and 13-4 be layered between a corresponding first refracting transparent thin film 12-1, 12-2, 12-3, or 12-4 and a corresponding metal thin film 14-1 or 14-2.

The transparent substrate 11 can be made of any material that has excellent light transmissivity and mechanical properties. For example, the transparent substrate 11 can be a thermal curing organic film or an Ultraviolet (UV) curing organic film that is generally made of a polymer-based material, such as Polyethylene Terephthalate (PET), acryl, Polycarbonate (PC), Urethane Acrylate (UA), polyester, Epoxy Acrylate (EA), or Polyvinyl Chloride (PVC). In addition, the transparent substrate 11 can be made of chemically tempered glass, such as soda-lime glass or aluminosilicate glass (SiO₂-Al₂O-Na₂O), in which the amounts of Na and Fe can be set low according to the intended use thereof.

The first refractive transparent thin films 12-1, 12-2, 12-3, and 12-4 can be made of a metal oxide that has a refractive index of 2.2 or more and a compressive strength ranging from 0.1 GPa to 0.2 GPa. In an example, the first refractive transparent thin films 12-1, 12-2, 12-3, and 12-4 can be made of niobium oxide (Nb₂O₅). In another example, the first refractive transparent thin films 12-1, 12-2, 12-3, and 12-4 are formed in a thickness ranging from 22 nm to 38 nm.

The second refractive transparent thin films 12-1, 12-2, 12-3, and 12-4 help the metal thin films 14-1 and 14-2 be crystalline and have a visible light transmissivity in a normally required range, for example, 80% or more. It is preferred that each of the second refractive transparent thin films 13-1, 13-2, 13-3, and 13-4 have a thickness that ranges from 10% to 65% of that of each of the first refractive transparent thin films 12-1, 12-2, 12-3, and 12-4. In an example, the second refractive transparent thin films 13-1, 13-2, 13-3, and 13-4 can be made of a metal oxide that has a refractive index of 2.0 or less. It is preferred that the second refractive transparent thin films 13-1, 13-2, 13-3, and 13-4 be made of zinc oxide (ZnO) doped with aluminum (Al) or titanium (Ti) at an amount ranging from 2 wt % to 10 wt %.

The metal thin films 14-1 and 14-2 are made of a material that has a high light transmissivity in the visible light range (from 380 nm to 780 nm) but a high light reflectivity in the infrared range. In an example, the metal thin films 14-1 and 14-2 can be made of silver (Ag) or an Ag alloy.

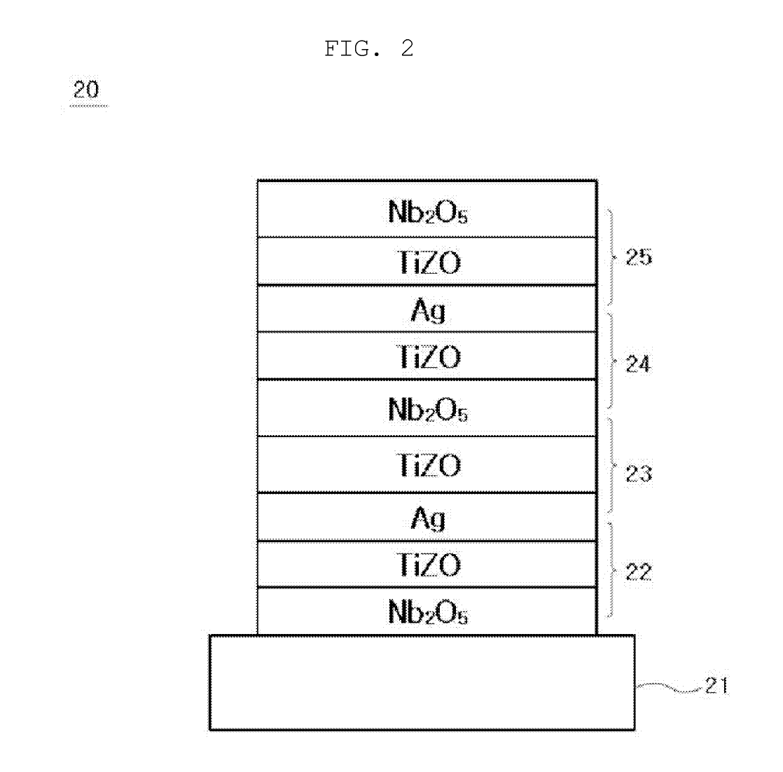

FIG. 2 is a cross-sectional view showing a transparent conductive film according to an example of the invention.

The transparent conductive film 20 of this example includes multilayer thin film structures 22, 23, 24, and 25 in which niobium oxide (Nb₂O₅), titanium-doped zinc oxide (TiZO), and Ag are repeatedly layered over a soda-lime glass 21. Here, TiZO and is layered between Nb₂O₅ and Ag.

Below, a description will be given of the results obtained by measuring the crystallinity of Ag, light transmissivity, and moisture resistance according to the thickness of constituent thin films of the transparent conductive film shown in FIG. 2.

TABLE 1

| | Film thickness (nm) | | | | | | | |
|---|---|---|---|---|---|---|---|---|
| | | | Thickness ratio | Ag | Light transmissivity (%) | | | Moisture |
| | Nb₂O₅ | TiZO | of TiZO (%) | Crystallinity | Average | @450 nm | @620 nm | resistance |
| Example 1 | 33 | 5 | 15.2 | 4.71 | 86 | 84 | 80 | Pass |
| Example 2 | 24 | 15 | 62.5 | 5.34 | 87 | 84 | 83 | Pass |
| Comparative | 35 | 2 | 5.7 | Amorphous | 61 | 60 | 62 | Fail |
| Example 1 | | | | | | | | |
| Comparative | 20 | 20 | 100 | 14.10 | 85 | 79 | 85 | Fail |
| Example 2 | | | | | | | | |

Here, the thickness ratio of TiZO was calculated using a formula: T₂/T₁×100 (%), where T₁ is the thickness of the Nb₂O₅ thin film and T₂ is the thickness of the TiZO thin film. In addition, the crystallinity of Ag was determined using the relative intensity of the Ag peak through measurement of the X-Ray Diffraction (XRD) pattern. The light transmissivity was measured using a Lambda-950 spectrophotometer. The average transmissivity throughout the entire wavelength range, the transmissivity at 450 nm wavelength, and the transmissivity at 620 nm wavelength were compared to each other considering the characteristics of the transparent conductive film that require high transmissivity throughout the entire range of visible light wavelengths. Moisture resistance was evaluated as “Pass” if the size of white defects within a predetermined area of the transparent conductive film, for example, a 29.5 cm×21 cm area, was smaller than 0.5 mm and the number of such white defects having the size smaller than 0.5 mm was smaller than 5, and as “Fail” if the size of white defects was 0.5 mm or more and the number of such white defects having a size of 0.5 mm or more was 5 or more.

In Examples 1 and 2 and Comparative Examples 1 and 2, Nb₂O₅ thin films having thicknesses of 33 nm, 24 nm, 35 nm, and 20 nm were formed over respective transparent substrates having a thickness of 0.5 mm which were cleaned using supersonic waves, by introducing a mixture of Ar and O₂ gases into a sputtering chamber and then sputtering Nb₂O₅ targets by Direct Current (DC) sputtering at a pressure of 5 mTorr and at a power density of 2 W/cm².

In addition, in Examples 1 and 2 and Comparative Examples 1 and 2, TiZO thin films having thicknesses of 5 nm, l5 nm, 2 nm, and 20 nm were formed over respective Nb₂O₅ thin films by introducing a mixture of Ar and O₂ gases into a sputtering chamber and then sputtering TiZO targets doped with Ti of 10% by DC sputtering at a pressure of 5 mTorr and at a power density of 2 W/cm².

Furthermore, in Examples 1 and 2 and Comparative Examples 1 and 2, Ag metal thin films having a thickness of 17 nm were formed over respective TiZO thin films by introducing Ar gas into a sputtering chamber and then sputtering Ag targets by DC sputtering at a pressure of 5 mTorr and at a power density of 1 W/cm².

In addition, in Examples 1 and 2 and Comparative Examples 1 and 2, TiZO thin films having thicknesses of 5 nm, 15 nm, 2 nm and 20 nm were formed over respective Ag metal thin films by introducing a mixture of Ar and O₂ gases into a sputtering chamber and then sputtering TiZO targets doped with Ti of 10% by DC sputtering at a pressure of 5 mTorr and at a power density of 2 W/cm².

Moreover, in Examples 1 and 2 and Comparative Examples 1 and 2, Nb₂O₅ thin films having thicknesses of 33 nm, 24 nm, 35 nm, and 20 nm were formed over respective TiZO thin films by introducing a mixture of Ar and O₂ gases into a sputtering chamber and then sputtering Nb₂O₅ targets by DC sputtering at a pressure of 5 mTorr and at a power density of 2 W/cm².

As in Comparative Example 1, if the ratio of the thickness of the TiZO thin film with respect to that of the Nb₂O₅ thin film was less than 10%, an amorphous Ag metal thin film that is not crystalline was obtained. When the amorphous Ag metal thin film was exposed to a hot and humid environment, the problem of white defects due to Ag cohesion occurred. Due to the instability of the Ag metal thin film, the thin film was non-uniform and had high reflectivity, which resulted in the decrease in visible light transmissivity.

As in Comparative Example 2, if the ratio of the thickness of the TiZO thin film with respect to that of the Nb₂O₅ thin film exceeded 65%, Ag crystallinity increased, whereas fracture occurred due to increased stress. Thus, Ag condensation occurred, which results in severe white defects. Due to the characteristics of the zinc oxide film, which absorbs short wavelengths, transmissivity in the range of 450 nm or less was lowered.

In contrast, as in Examples 1 and 2, if the ratio of thickness of the TiZO thin film with respect to that of the Nb₂O₅ thin film ranged from 10% to 65%, the thicker the zinc oxide layer was, the higher the crystallinity of the Ag metal film became. This can prevent moisture from causing condensation of Ag, thereby maintaining an excellent appearance even in a hot and humid environment. In addition, it is possible to obtain high transmissivity of 80% or more throughout the entire range of visible light wavelengths.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transparent conductive film comprising:
first refractive transparent thin films;
metal thin films, wherein the first refractive transparent thin films and metal thin films are repeatedly layered over a transparent substrate; and
second refractive thin films having a smaller refractive index than the first refractive thin films, wherein each of the second refractive thin films is interposed between a corresponding one of the first refractive transparent thin films and a corresponding one of the metal thin films,
wherein each of the second refractive thin films has a thickness ranging from 10% to 65% of that of each of the first refractive thin films.

2. The transparent conductive film according to claim 1, wherein the first refractive transparent thin films are made of a metal oxide having a refractive index of 2.2 or more.

3. The transparent conductive film according to claim 1, wherein the first refractive transparent thin films are made of Nb₂O₅.

4. The transparent conductive film according to claim 1, wherein the second refractive transparent thin films are made of ZnO doped with Al or Ti.

5. The transparent conductive film according to claim 4, wherein the Al or Ti has a content ranging from 2 wt % to 10 wt %.

6. The transparent conductive film according to claim 1, wherein the metal thin films are made of Ag or an Ag alloy.

7. A display filter comprising the transparent conductive film recited in claim 1.
